(19) United States
(12) Patent Application Publication
(10) Pub. No.: US 2023/0225580 A1
(43) Pub. Date: Jul. 20, 2023

(54) ROBOT CLEANER AND ROBOT CLEANER CONTROL METHOD

(71) Applicant: LG ELECTRONICS INC., Seoul (KR)

(72) Inventor: Jae Won JANG, Seoul (KR)

(21) Appl. No.: 17/928,653

(22) PCT Filed: Sep. 4, 2020
(86) PCT No.: PCT/KR2020/011945

§ 371 Date: Nov. 30, 2022

(30) Foreign Application Priority Data
Jun. 2, 2020 (KR) 10-2020-0066430

(51) Int. Cl. A47L 11/40; G05D 1/02

(52) U.S. Cl. CPC A47L 11/4011; G05D 1/0214; G05D 1/0238; G05D 1/027; G05D 1/0272; A47L 2201/04; G05D 2201/0215

(57) ABSTRACT

Provided are a robot cleaner including: a drive part configured to apply a driving force required to drive the robot cleaner; a sensor configured to obtain at least one of information about a travel state of the robot cleaner and information about surroundings of the robot cleaner; and a controller configured to determine at least one reference trajectory on a coordinate system of a cleaning area, and to compensate for a degree to which the robot cleaner is spaced apart from the reference trajectories based on at least one of a position and an direction of the robot cleaner, which are determined based on the at least one information obtained by the sensor, and a method for controlling a travel of the robot cleaner.

### TECHNICAL FIELD

This disclosure relates to a method for controlling an operation of a robot cleaner and the robot cleaner in which such an operation control method is implemented.

### BACKGROUND ART

A vacuum cleaner is an equipment that performs cleaning by suctioning or wiping dusts or foreign substances in a cleaning area.

Such a vacuum cleaner may be classified into a manual vacuum cleaner in which a user directly moves the vacuum cleaner to perform cleaning, and an automatic vacuum cleaner that performs cleaning while travelling by itself

In general, a robot cleaner 100 is an equipment that automatically performs a predetermined operation while travelling in a predetermined area by itself without any manipulation by a user. The robot cleaner 100 detects an obstacle existing in the predetermined area and approaches or avoid the obstacle to perform cleaning. The robot cleaner 100 may include a robot cleaner that performs cleaning while travelling in a predetermined area.

The robot cleaner may be implemented in a sweep mode of sweeping a floor, which is a surface to be cleaned, a suction mode, or a wet mode of spraying water on the floor to clean the floor in a wet manner.

The robot cleaner moves in a designated area to remove foreign substances in a predetermined mode. When the robot cleaner performs cleaning while repeatedly moving in the same area, a larger amount of foreign substances may be removed from the area. However, this may increase the time it takes for the robot cleaner to clean the entire area to be cleaned. Therefore, the robot cleaner needs to be efficiently moved in a designated area to be cleaned.

The robot cleaner needs to travel while repeatedly performing an operation of cleaning a cleaning area to improve a degree to which objects to be cleaned are removed. Therefore, the robot cleaner needs to efficiently travel in the cleaning area while repeatedly performing the operation of cleaning the cleaning area.

### DISCLOSURE OF INVENTION

### Technical Goals

The present disclosure provides a robot cleaner which is controlled to recognize a predetermined area to be cleaned and clean the recognized predetermined area while travelling in the recognized predetermined area in an efficient manner, and a control method therefor.

### Technical Solutions

An aspect provides a robot cleaner which may include: a drive part configured to apply a driving force required to drive the robot cleaner; a sensor configured to obtain at least one of information about a travel state of the robot cleaner and information about surroundings of the robot cleaner; and a controller configured to determine at least one reference trajectory on a coordinate system of a cleaning area, and to compensate for a degree to which the robot cleaner is spaced apart from the reference trajectories based on at least one of a position and an direction of the robot cleaner, which are determined based on the at least one information obtained by the sensor.

Another aspect provides a method for controlling a travel of a robot cleaner, the method which may include: determining reference trajectories on a coordinate system of a cleaning area; determining at least one of a position and an direction of the robot cleaner based on at least one of information about a travel state of the robot cleaner and information about surroundings of the robot cleaner; and compensating for a degree to which the robot cleaner is spaced apart from the reference trajectory based on the at least one of the position and the direction.

### Effects

According to the present disclosure, by efficiently managing a cleaning area, a robot cleaner may clean the cleaning area in a quick and efficient manner while travelling in the cleaning area.

### BRIEF DESCRIPTION OF DRAWINGS

FIG. 1 illustrates a block diagram of a robot cleaner according to an example embodiment.

FIG. 2 is a flowchart for explaining a method for controlling a travel of the robot cleaner according to an example embodiment.

FIGS. 3A to 3C illustrate patterns in which the robot cleaner may travel along reference trajectories set according to an example embodiment.

FIG. 4 illustrates a state in which the robot cleaner moves between set reference trajectories according to an example embodiment.

FIGS. 5A and 5B are views illustrating states in which the robot cleaner moves between reference trajectories based on a predetermined condition according to an example embodiment.

FIGS. 6A to 6D are views illustrating states in which the robot cleaner travels along reference trajectories and an intermediate reference trajectory according to an example embodiment.

FIGS. 7A to 7E are views illustrating states in which the robot cleaner travels in a reciprocate travel mode according to an example embodiment.

FIGS. 8A and 8B are views illustrating states in which the robot cleaner travels in a reciprocate travel mode along a first reference trajectory, a second reference trajectory, and a third reference trajectory according to an example embodiment.

FIGS. 9A and 9B are views illustrating states in which a robot cleaner 900 performs cleaning through an operation of travelling in a reciprocate travel mode over reference trajectories and an operation of moving forward or backward along reference trajectories according to an example embodiment.

### BEST MODE FOR CARRYING OUT THE INVENTION

According to an example embodiment, a robot cleaner may include: a drive part configured to apply a driving force required to drive the robot cleaner; a sensor configured to obtain at least one of information about a travel state of the robot cleaner and information about surroundings of the robot cleaner; and a controller configured to determine reference trajectories on a coordinate system of a cleaning area, and to compensate for a degree to which the robot cleaner is spaced apart from the reference trajectories based on at least one of a position and an direction of the robot cleaner, which are determined based on the at least one information obtained by the sensor.

In an aspect, the sensor may include a gyroscope configured to obtain acceleration information of the robot cleaner, a movement distance sensor configured to obtain information about a movement distance of the robot cleaner, and an obstacle sensor configured to sense an obstacle in the cleaning area.

In an aspect, the controller may be configured to determine the reference trajectories composed of a plurality of linear trajectories on the cleaning area.

In an aspect, the controller may be configured to control the drive part to drive the robot cleaner in at least one of modes including a linear movement, a radial rotation and a change in direction based on the reference trajectories.

In an aspect, when a predetermined condition is determined to be satisfied, the controller may be configured to control the drive part such that robot cleaner travels along a second reference trajectory adjacent to a first reference trajectory along which the robot cleaner is traveling among the reference trajectories.

In an aspect, the controller may be configured to: determine, a the predetermined condition, whether or not an obstacle exists on the first reference trajectory along which the robot cleaner is traveling among the reference trajectories based on the at least one information obtained by the sensor; and when the obstacle is determined to exist on the first reference trajectory, control the drive part such that the robot cleaner travels on the second reference trajectory adjacent to the first reference trajectory.

In an aspect, the controller may be configured to: when the robot cleaner is determined to be entered the second reference trajectory, determine whether or not the obstacle exists on the second reference trajectory; and when the obstacle is determined to not exist on the second reference trajectory, control the drive part such that the robot cleaner travels in a direction in which the robot cleaner is traveling on the first reference trajectory.

In an aspect, the controller may be configured to, when the obstacle is determined to exist on the second reference trajectory, control the drive part such that the robot cleaner travels in a opposite direction which is opposite to the direction in which the robot cleaner is traveling on the first reference trajectory.

In an aspect, a pattern in which the robot cleaner moves from the first reference trajectory to the second reference trajectory may include at least one of a linear pattern and an arc pattern.

In an aspect, the controller may be configured to: set at least one intermediate reference trajectory between the first reference trajectory and the second reference trajectory; and change a pattern in which the robot cleaner moves from the first reference trajectory to the second reference trajectory when the robot cleaner passes along the at least one intermediate reference trajectory.

In an aspect, the controller may be configured to control the drive part such that the robot cleaner travels along the first reference trajectory and the second reference trajectory in a reciprocate travel mode according to the predetermined condition.

In an aspect, the controller may be configured to, when travelling in the reciprocate travel mode, set a position of the intermediate reference trajectory while the robot cleaner moves from the first reference trajectory to the second reference trajectory, and a position of the intermediate reference trajectory while the robot cleaner returns from the second reference trajectory to the first reference trajectory, to be different from each other.

In an aspect, the controller may be configured to control the drive part such that a position and a direction of the robot cleaner on at least one of the first reference trajectory and the second reference trajectory before and after travelling in the reciprocate travel mode are identical to each other.

In an aspect, the controller may be configured to control the drive part such that at least one of a position and a direction of the robot cleaner on the first reference trajectory and the second reference trajectory before and after travelling in the reciprocate travel mode are different from each other.

In an aspect, the controller may be configured to control the drive part such that the robot cleaner travels by a predetermined distance on the first reference trajectory and the second reference trajectory while travelling in the reciprocate travel mode.

In an aspect, the controller may be configured to: set a third reference trajectory located in a direction opposite to a place where the second reference trajectory is located with respect to the first reference trajectory; and control the drive part such that the robot cleaner travels along the first reference trajectory and the second reference trajectory in a first reciprocate travel mode, and subsequently travels along the first reference trajectory and the third reference trajectory in a second reciprocate travel mode.

In an aspect, the controller may be configured to control the drive part such that, after travelling in the first reciprocate travel mode, the robot cleaner travels along the first reference trajectory and subsequently travels in the second reciprocate travel mode.

In an aspect, the controller may be configured to control the drive part such that a position of the robot cleaner on the first reference trajectory after travelling in the first reciprocate travel mode is identical to a position of the robot cleaner on the second reference trajectory after travelling in the second reciprocate travel mode.

In an aspect, the controller may be configured to control the drive part such that, after travelling in the first reciprocate travel mode and the second reciprocate travel mode, the robot cleaner travels along the first reference trajectory and subsequently travels in the first reciprocate travel mode and the second reciprocate travel mode.

According another aspect, a method for controlling a travel of a robot cleaner may include: determining reference trajectories on a coordinate system of a cleaning area; determining at least one of a position and an direction of the robot cleaner based on at least one of information about a travel state of the robot cleaner and information about surroundings of the robot cleaner; and compensating for a degree to which the robot cleaner is spaced apart from the reference trajectories based on the at least one of the position and the direction.

### MODE FOR CARRYING OUT THE INVENTION

Hereinafter, example embodiments of the present disclosure will be clearly described in detail with reference to the accompanying drawings at such an extent that they may be readily practiced by those ordinary skilled in the art.

In order to clearly describe the present disclosure, detailed descriptions of parts irrelevant to the present disclosure will be omitted, and the same reference numerals will be given to the same constituent elements throughout the specification. Further, some embodiments of the present disclosure will be described in detail through exemplary drawings. Further, in adding reference numerals to constituent elements in each figure, the same constituent elements are made to have the same symbols as possible even if they are displayed on the other figures. In addition, detailed description thereof is omitted in the case where it is determined that detailed description of related known configurations or functions in describing the example embodiments of the present disclosure prevents understanding of the example embodiments of the present disclosure.

In example embodiments, the terms including ordinal numbers such as a “first”, “second”, “A”, “B”, (a), “(b)” and the like may be used to describe various constituent elements. These terms may be merely used to distinguish one constituent element from another constituent element, but essences, sequences, orders, or number of the respective constituent elements are not limited by such terms. When one constituent element is referred to as being “connected” or “coupled” to another constituent element, the one constituent elements may be directly connected or coupled to another constituent element, or may be connected or coupled to another constituent element by intervening yet another constituent element therebetween.

The term “includes”, “is configured”, “has” or the like used herein are intended to include features, numeric characters, steps, operations, constituent elements, parts, or a combination thereof, and needs be understood not to exclude one or more other features, numeric characters, steps, operations, constituent elements, parts, or a combination thereof, or additional features and the like.

In addition, in implementing the present disclosure, constituent elements may be described while being further divided for the sake of convenience in description. These constituent elements may be provided in one device or module, or one constituent element may be provided in each of a plurality of devices or modules.

Hereinafter, a robot cleaner according to an example embodiment will be described.

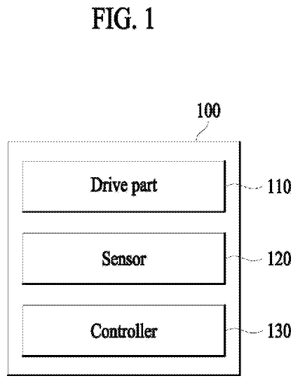

FIG. 1 illustrates a block diagram of a robot cleaner 100 according to an example embodiment. In an example embodiment, the robot cleaner 100 may include a drive part 110 configured to provide a driving force required to drive the robot cleaner 100, a sensor 120 configured to obtain at least one of information about a travel state of the robot cleaner 100 and surrounding information of the robot cleaner 100, and a controller 130 configured to control the drive part 110. The controller 130 may determine reference trajectories on a coordinate system of a cleaning area, and compensate for a degree to which the robot cleaner 100 is spaced apart from the reference trajectory based on at least one of a position and a direction of the robot cleaner, which is determined according to the information obtained by the sensor 120.

In an example embodiment, the drive part 110 included in the robot cleaner 100 may include a plurality of wheels so that the robot cleaner 100 may easily ride over an obstacle such as a threshold.

In an example embodiment, the robot cleaner 100 may include a plurality of pad assemblies that is driven by the drive part 110. In an example embodiment, the plurality of pad assemblies may include a rotary plate that is rotatable by virtue of a driving force of a motor, and a pad provided under the rotary plate. In an example embodiment, the pad assemblies are fixed while being titled at a predetermined angle in different directions. Thus, the rotary plate has a pressing point in contact with the ground so that the robot cleaner 100 may travel with the rotation of the rotary plate. In an example embodiment, the robot cleaner 100 may perform cleaning while travelling with the rotation of the pad of the pad assemblies.

In an example embodiment, with the operation of the wheels and/or the pad assemblies driven by the plurality of motors included in the drive part 110, the robot cleaner 100 may travel in various modes, such as moving linearly forward or backward, travelling while rotating along an arc trajectory, rotating in place and the like. That is, the robot cleaner 100 may move linearly or rotate according to a difference in speed between the wheels and/or pad assemblies driven by each of the plurality of motors.

In an example embodiment, the controller 130 may include at least one of a random access memory (RAM), a read-only memory (ROM), a control processing processor (CPU), a graphic processing part (GPU), and a bus (BUS), which may be connected to one another.

In an example embodiment, the robot cleaner 100 may include the sensor 120 provided with sensors configured to sense various pieces of data relating to an operation and state of the robot cleaner 100.

In an example embodiment, the sensor 120 may include a light detection and ranging (Lidar). The Lidar may detect, using a laser light, an object such as an obstacle based on a time-of-flight (TOF) of a transmission signal and a reception signal or a phase difference between the transmission signal and the reception signal.

In an example embodiment, the Lidar may detect a distance between the robot cleaner 100 and an object, a relative speed between the robot cleaner 100 and the object, and a position of the object.

In an example embodiment, the Lidar may be provided as a portion of constituent elements of an obstacle detection sensor. Further, the Lidar may be provided as a sensor for creating a map.

Further, the obstacle detection sensor may detect an object, specifically an obstacle, which exist in a travel (movement) direction of a moving robot, and transmit information about the obstacle to the controller 130. In this case, the controller 130 may control the motion of the robot cleaner 100 according to the position of the detected obstacle.

In an example embodiment, the sensor 120 may use a gyro sensor, a wheel sensor, an acceleration sensor, or the like.

When the robot cleaner 100 moves in an operation mode, the gyro sensor detects a rotational direction of the robot cleaner 100 and detects a rotational angle. The gyro sensor detects an angular velocity of the robot cleaner 100 and outputs a voltage value corresponding to the angular velocity. The controller 130 calculates the rotational direction and the rotational angle using the voltage value output from the gyro sensor.

In an example embodiment, a movement distance sensor included in the sensor 120 senses a change in position according to the movement of the robot cleaner 100, senses a position of the robot cleaner 100, for example, a movement distance displaced from an initial position, and detects an actual position information of the robot cleaner 100. In an example embodiment, the movement distance sensor may include an encoder that detects the number of rotations of a plurality of motors included in the drive part 110 in order to sense the movement distance of the robot cleaner 100. In an example embodiment, the movement distance sensor may sense the number of rotations of the wheels and/or the pad assemblies included in the drive part 110. In an example embodiment, the movement distance sensor, which may be a rotary encoder, may detect the number of rotations and output the same to the controller 130. In an example embodiment, the controller 130 may calculate a rotational speed of the wheels using the number of rotations. Further, the controller 130 may calculate the rotational angle using a difference in the number of rotations.

The acceleration sensor detects a speed change of the robot cleaner 100, for example, a change of the robot cleaner 100 according to start, stop, direction change, collision with an object, or the like. The acceleration sensor may be attached to a position adjacent to a main wheel or an auxiliary wheel to detect slippage or idling state of the respective wheel.

Further, the acceleration sensor may sense the speed change of the robot cleaner 100. That is, the acceleration sensor detects an impact level according to the speed change and outputs a voltage value corresponding to the impact level. Accordingly, the acceleration sensor may function as an electronic bumper.

In an example embodiment, the sensor 120 includes at least one of a gyroscope configured to obtain acceleration information of the robot cleaner 100, the movement distance sensor configured to obtain information about the movement distance of the robot cleaner 100, and an obstacle sensor configured to detect an obstacle in a cleaning area.

In an example embodiment, the sensor 120 may be disposed at the robot cleaner 100 toward one side.

In an example embodiment, the sensor 120 is disposed on a front side of the robot cleaner 100 to sense an obstacle, terrain or the like in front so that a leading end of the robot cleaner 100 does not collide with the obstacle or the like.

In an example embodiment, the sensor 120 may be configured to further perform other sensing functions in addition to such sensing functions.

For example, the sensor 120 may include a camera configured to capture an image of surroundings. The camera may include a lens and an image sensor. Further, the camera converts an image around the robot cleaner 100 into an electrical signal that may be processed by the controller 130. For example, the camera may transmit an electrical signal corresponding to an upper image to the controller 130. The electrical signal corresponding to the upper image may be used when the controller 130 detects the position of the robot cleaner 100.

Further, the sensor 120 may detect obstacles such as a wall, furniture, cliff or the like on a travel plane or travel path of the robot cleaner 100. Further, the sensor 120 may detect the presence of a docking device that charges a battery. Further, the sensor 120 may sense ceiling information and may map a travel area or a cleaning area of the robot cleaner 100.

Further, the sensor 120 may include at least one of an external signal detection sensor, a front detection sensor, a cliff detection sensor, a two-dimensional (2D) camera sensor, and a three-dimensional (3D) camera sensor.

The external signal detection sensor may detect a signal outside the robot cleaner 100. As an example, the external signal detection sensor may be an infrared ray sensor, an ultrasonic sensor, a radio frequency (RF) sensor, or the like.

The robot cleaner 100 may receive a guide signal generated from a charging station using the external signal detection sensor to confirm a position and direction of the charging station. In this case, the charging station may transmit a guide signal indicating a direction and a distance so that the robot cleaner 100 is able to come back. That is, the robot cleaner 100 may receive the signal generated from the charging station, determine a current position of the robot cleaner 100, set a movement direction thereof, and return to the charging station.

Further, the front detection sensor may be installed at regular intervals in front of the robot cleaner 100, specifically, along an outer peripheral surface of a lateral surface of the robot cleaner 100. The front detection sensor may be located on at least one lateral side of the robot cleaner 100 to detect an obstacle in the front. The front detection sensor may transmit, to the controller 130, information obtained by detecting an object, specifically the obstacle, existing in the movement direction of the robot cleaner 100. That is, the front detection sensor may detect protrusions, household appliances, furniture, wall surfaces, wall corners, or the like, which exist on a movement path of the robot cleaner 100, and transmit information relating thereto to the controller 130.

As an example, the front detection sensor may be an infrared ray sensor, an ultrasonic sensor, an RF sensor, a geomagnetic sensor, or the like. The robot cleaner 100 uses one type of sensor or two or more types of sensors among various types of front detection sensors described above as needed.

For example, in general, the ultrasonic sensor may be mainly used to detect a long-distance obstacle. The ultrasonic sensor includes a transmitter and a receiver. The controller 130 may determine the presence or absence of an obstacle according to whether or not an ultrasonic wave radiated from the transmitter is reflected at the obstacle and is received by the receiver, and calculate a distance from the obstacle using an ultrasonic wave radiation time and an ultrasonic wave reception time.

Further, the controller 130 may detect information relating to a size of the obstacle by comparing the ultrasonic wave radiated from the transmitter with the ultrasonic wave received by the receiver. For example, the controller 130 may determine that the size of the obstacle increases as a larger amount of ultrasonic waves are received by the receiver.

In an example embodiment, a plurality (for example, five) of ultrasonic sensors may be installed on the front lateral side of the robot cleaner 100 along the outer circumferential surface thereof. In this case, the ultrasonic sensors may be installed in the front of the robot cleaner 100 in a state in which transmitters and receivers are alternately arranged.

That is, the transmitters may be arranged to be spaced apart from the center of the front of a main body to left and right sides. One or more transmitters may be arranged between the receivers to form a reception area in which the ultrasonic signal reflected from the obstacle or the like is received. With such an arrangement, the reception area may be expanded with a reduced number of sensors. A transmission angle of the ultrasonic wave may be maintained within a range that does not affect different signals to prevent a crosstalk phenomenon. Further, reception sensitivities of the receivers may be set differently.

Further, the ultrasonic sensor may be installed upward by a certain angle so that the ultrasonic wave transmitted from the ultrasonic sensor are output upward. In this case, the ultrasonic sensor may further include a blocking member to prevent the ultrasonic wave from being radiated downward.

Further, as described above, the front detection sensor may use two or more types of sensors together. Thus, the front detection sensor may use one of the infrared ray sensor, the ultrasonic sensor, and the RF sensor.

As an example, the front detection sensor may include the infrared ray sensor in addition to the ultrasonic sensor.

The infrared ray sensor may be installed on the outer peripheral surface of the robot cleaner 100 together with the ultrasonic sensor. The infrared ray sensor may also detect an obstacle existing in the front or on the lateral side of the robot cleaner 100 and transmit information about the obstacle to the controller 130. That is, the infrared ray sensor detects protrusions, household appliances, furniture, wall surfaces, wall corners, or the like existing on the movement path of the robot cleaner 100 and transmits information relating thereto the controller 130. Accordingly, the robot cleaner 100 may move within a specific area in a state in which the main body does not collide with the obstacle.

Further, the cliff detection sensor may mainly use various types of optical sensors to detect an obstacle on the floor that supports the main body of the robot cleaner 100.

That is, the cliff detection sensor is installed on the rear side of the robot cleaner 100 at the side of the floor, but may be installed at another position depending on the type of the robot cleaner 100. The cliff detection sensor is located on the rear surface of the robot cleaner 100 to detect an obstacle on the floor. The cliff detection sensor may include an infrared ray sensor, an ultrasonic sensor, an RF sensor, a position sensitive detector (PSD) sensor and the like, each of which includes a light emitting part and a light receiving part, like the obstacle detection sensor.

For example, one of such cliff detection sensors may be installed in front of the robot cleaner 100, and the other two cliff detection sensors may be installed relatively beyond the cliff detection sensor.

For example, the cliff detection sensor may be the PSD sensor, and may also include a plurality of different types of sensors.

The PSD sensor detects a short and long distance position of an incident light with a single p-n junction using a semiconductor surface resistance. The PSD sensor may include a one-dimensional PSD sensor that detects light in merely one axial direction and a two-dimensional PSD sensor that detects a position of light on a plane, which may have a pin photodiode structure. The PSD sensor is a type of infrared ray sensor, and measures a distance to an obstacle by transmitting infrared rays and measuring an angle of infrared rays reflected from the obstacle. That is, the PSD sensor calculates the distance to the obstacle using a triangulation method.

The PSD sensor includes a light emitting part that emits an infrared ray to an obstacle and a light receiving part that receives the infrared ray reflected from the obstacle, and may be generally configured in a module form. When the obstacle is detected using the PSD sensor, a stable measurement value may be obtained regardless of a difference in reflectance and a difference in color of the obstacle.

Further, the controller 130 may detect a cliff and analyze a depth thereof by measuring an infrared ray angle between a light emitting signal of the infrared ray emitted from the cliff detection sensor toward the ground and a reflection signal received by being reflected from the obstacle.

Further, the controller 130 may check a ground state of the cliff detected by the cliff detection sensor, and may determine whether or not the robot cleaner 100 may pass through the cliff according to the ground state. For example, the controller 130 may determine the presence or absence of a cliff and a depth of the cliff using the cliff detection sensor, and then control the robot cleaner 100 to pass through the cliff merely when the cliff detection sensor detects the reflection signal from the cliff.

As another example, the controller 130 may determine a lift-up state of the robot cleaner 100 using the cliff detection sensor.

Further, the two-dimensional camera sensor may be provided on one surface of the robot cleaner 100 to obtain image information relating to the surrounding of the main body during movement.

The optical flow sensor may convert a lower image input from an image sensor provided inside the sensor to generate image data of a predetermined format. The generated image data may be stored in a memory (not illustrated).

Further, one or more light sources may be installed adjacent to the optical flow sensor. One or more light sources irradiate light to a predetermined area of the floor surface captured by the image sensor. That is, in a case in which the robot cleaner 100 moves in a specific area along a floor surface, when the floor surface is flat, a certain distance is maintained between the image sensor and the floor surface. On the other hand, in a case in which the robot cleaner 100 moves on a floor surface whose surface state is ununiform, the image sensor and the floor surface may be spaced apart from each other by a certain distance or more due to irregularities and obstacles on the floor surface. In this case, the one or more light sources may be controlled by the controller 130 to adjust the amount of light irradiated. The light source may be a light emitting element capable of controlling an amount of light therefrom, for example, a light emitting diode (LED).

By using the optical flow sensor, the controller 130 may detect a position of the robot cleaner 100 irrespective of the sliding of the robot cleaner 100. The controller 130 may calculate a movement distance and a movement direction by comparing and analyzing pieces of data about the image captured by the optical flow sensor over time, and may calculate the position of the robot cleaner 100 based on the calculated distance and direction. By using information about a lower image of the robot cleaner 100 obtained by the optical flow sensor, the controller 130 may perform a strong correction against slipping with respect to a position of the robot cleaner 100 calculated by another part.

The three-dimensional camera sensor may be attached to one surface or a portion of the main body of the robot cleaner 100 to generate three-dimensional coordinate information relating to the surrounding of the main body.

That is, the three-dimensional camera sensor may be a three-dimensional depth camera (3D Depth Camera) that calculates a near distance between the robot cleaner 100 and an object to be captured.

Specifically, the three-dimensional camera sensor may capture a two-dimensional image relating to the surrounding of the main body, and may generate plural pieces of three-dimensional coordinate information corresponding to the captured two-dimensional image.

In an example embodiment, the three-dimensional camera sensor may be implemented in a stereo vision mode in which two or more cameras for capturing a two-dimensional image in the art, and two or more images obtained by the two or more cameras are combined with each other to generate three-dimensional coordinate information.

Specifically, the three-dimensional camera sensor according to an example embodiment may include a first pattern irradiation part that irradiates a first pattern of light downward toward the front of the main body, a second pattern irradiation part that irradiates a second pattern of light upward toward the front of the main body, and an image acquisition part that acquires an image of the front of the main body. Accordingly, the image acquisition part may acquire an image of a region to which the first pattern of light and the second pattern of light are incident.

In another example embodiment, the three-dimensional camera sensor includes an infrared ray pattern irradiation part that irradiates an infrared ray pattern in addition to a single camera. The three-dimensional camera sensor may capture an image of a shape of the infrared ray pattern irradiated from the infrared ray pattern irradiation part projected on the object to be captured, to measure a distance between the three-dimensional camera sensor and the object to be captured. The three-dimensional camera sensor may be an infra-red (IR) type of three-dimensional camera sensor.

In another example embodiment, the three-dimensional camera sensor may include a light emitting part that emits light together with a single camera, receive a portion of laser beams radiated from the light emitting part and reflected from the object to be captured, and analyze the received laser beams to measure a distance between the camera sensor and the object to be captured. The three-dimensional camera sensor may be a three-dimensional camera sensor using the time-of-flight (TOF) mode.

Specifically, the three-dimensional camera sensor as described above is configured to irradiate laser beams to extend in at least one direction. As an example, the three-dimensional camera sensor may include a first laser and a second laser. The first laser may irradiate linear laser beams that intersects with each other, and the second laser may irradiate a single linear laser beam. With such configurations, the lowest laser may be used to detect an obstacle on the floor, the uppermost laser may be used to detect an obstacle in the upper portion, and an intermediate laser between the lowest laser and the uppermost laser may be used to detect an obstacle in an intermediate portion.

In an example embodiment, the controller 130 may drive the robot cleaner 100 with the drive part 110, and receive the information obtained by the sensor 120 to control the robot cleaner 100 such that the robot cleaner 100 performs cleaning while travelling in various modes.

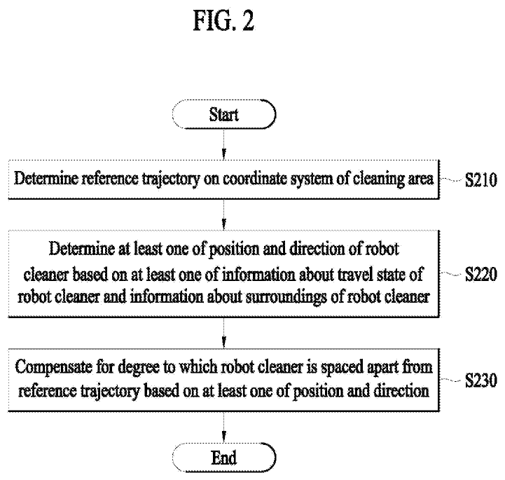

FIG. 2 is a flowchart for explaining a method for controlling a travel of the robot cleaner 100 according to an example embodiment.

In operation S210, the robot cleaner 100 may set a coordinate system of a cleaning area according to an example embodiment.

In an example embodiment, the controller 130 may set the coordinate system of the cleaning area to be cleaned by the robot cleaner 100, and may determine reference trajectories on such a coordinate system.

In an example embodiment, the coordinate system may be a domain in which reference trajectories, which is a reference the robot cleaner 100 follows to perform the cleaning while travelling in the cleaning area, is expressed. In an example embodiment, the coordinate system may be implemented with a reference coordinate previously set with respect to the robot cleaner 100 and a two-dimensional or three-dimensional space on a recognized cleaning area.

In an example embodiment, the robot cleaner 100 may arbitrarily set a coordinate system based on the information acquired by the sensor 120 (for example, the image data acquired by the camera, the information acquired by the gyroscope, and the information about the movement distance of the robot cleaner 100 acquired by the movement distance sensor and the like).

In operation S220, the robot cleaner 100 may determine at least one of a position and a direction of the robot cleaner 100 based on at least one of information about the travel state of the robot cleaner 100 and information about the surroundings of the robot cleaner 100.

In an example embodiment, the controller 130 may determine at least one of the position and the direction of the robot cleaner 100 based on the information obtained by the sensor 120. In an example embodiment, the information obtained by the sensor 120 may be transmitted to the controller 130. The controller 130 may use the information received from the sensor 120 to determine at least one of the position and the direction of the robot cleaner (100) on the set coordinate system.

In an example embodiment, when at least one of the position and the direction of the robot cleaner 100 on the coordinate system is determined, the controller 130 may control the drive part 110 so that the robot cleaner 100 travels along the reference trajectory determined on the coordinate system.

In an example embodiment, the reference trajectory may be defined as reference trajectories along which the robot cleaner 100 travels. In an example embodiment, the robot cleaner 100 may travel while following the reference trajectory. For example, when the reference trajectory is set to have a plurality of straight lines, the robot cleaner 100 may perform cleaning while linearly traveling along the plurality of straight lines. In an example embodiment, the robot cleaner 100 may travel in various modes other than a linear travel mode of travelling with reference to the reference trajectory. This will be described later in various example embodiments.

In an example embodiment, the robot cleaner 100 may travel along the reference trajectory composed of a plurality of linear trajectories on the coordinate system of the cleaning area. In an example embodiment, in a case in which the robot cleaner 100 is set to perform cleaning while traveling along the plurality of linear trajectories, the robot cleaner 100 may travel in the cleaning area in a zigzag pattern along the plurality of linear trajectories. In an example embodiment, when the robot cleaner 100 travels in the cleaning area in the zigzag pattern, the robot cleaner may move over the plurality of linear trajectories. The robot cleaner 100 may move over the plurality of reference trajectories in various patterns, thus further cleaning spaces between the plurality of reference trajectories.

In an example embodiment, the fact that the robot cleaner 100 travels according to the reference trajectory may be understood to mean that a position which is a reference of various operation modes in which the robot cleaner 100 may operate is set on the reference trajectory.

In operation S230, the robot cleaner 100 may compensate for a degree to which the robot cleaner 100 is spaced apart from the reference trajectory based on at least one of the position and the direction determined in operation S220.

In an example embodiment, the robot cleaner 100 set to travel along the reference trajectory may determine the degree to which the robot cleaner 10 is spaced apart from the reference trajectory. In an example embodiment, the robot cleaner 100 may perform cleaning while travelling along a travel trajectory that coincides with the reference trajectory. However, the robot cleaner 100 may travel along a trajectory that deviates from the reference trajectory, depending on surrounding conditions of the robot cleaner 100 (for example, the presence of an external force applied to the robot cleaner 100, a slippery degree of the flood on which the robot cleaner 100 is travelling, and the like). In an example embodiment, since the robot cleaner 100 may determine at least one of the position and the direction of the robot cleaner 100 on the coordinate system based on the information obtained by the sensor 120, the robot cleaner 100 may determine how far it is traveling on the reference trajectory or how much it is traveling in a direction inclined compared to the direction of the reference trajectory. In an example embodiment, the controller 130 may determine how far the robot cleaner 100 is spaced apart from the reference trajectory in terms of the position and the direction, and may control the drive part 110 to compensate for a distance at which the robot cleaner 100 is spaced apart from the reference trajectory.

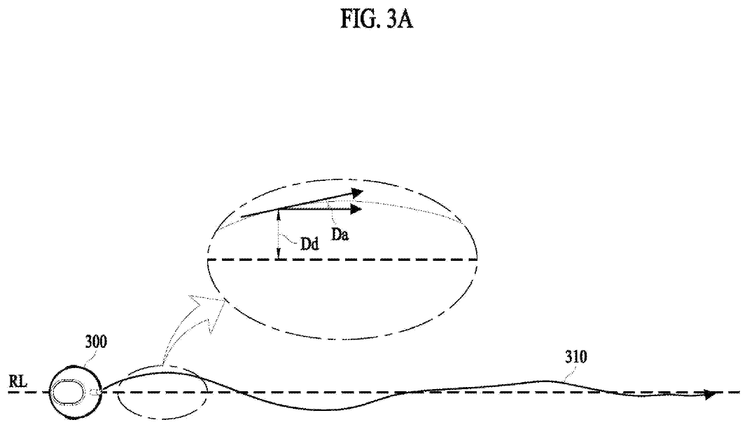

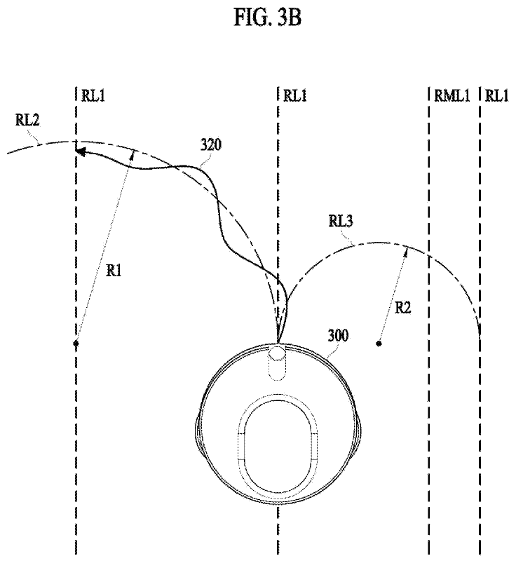

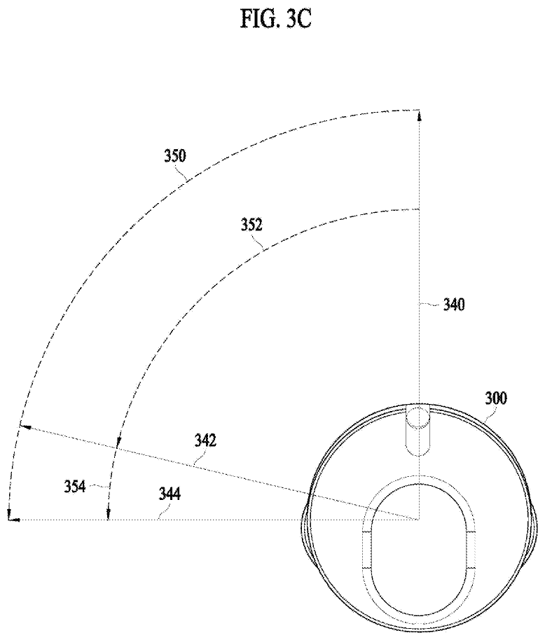

FIGS. 3A to 3C illustrate patterns in which a robot cleaner 300 travels along a set reference trajectory according to an example embodiment. The robot cleaner 300 illustrated in FIGS. 3A to 3C may correspond to the robot cleaner 100 of FIG. 1.

Referring to FIG. 3A, in an example embodiment, the robot cleaner 300 may be set to travel along a reference trajectory RL. The reference trajectory RL may have a linear shape. In an example embodiment, even though the reference trajectory RL has a linear shape, an actual travel path 310 may not have a linear shape depending on travel conditions around the robot cleaner 300. In an example embodiment, the robot cleaner 300 may determine at least one of a position and a direction of the robot cleaner 300 based on the information obtained by the sensor 120. Thus, a degree to which the robot cleaner 300 is displaced from the reference trajectory RL may be determined. For example, based on the information obtained by the sensor 120, the controller 130 may determine a distance at the robot cleaner 300 is displaced from the reference trajectory RL based on at least one of a position and a direction of the robot cleaner 300 on a coordinate system, which are determined at a predetermined time point. Referring to FIG. 3A, the controller 130 may determine a displacement distance Dd between the reference trajectory RL and the travel path 310 and a displacement angle Da between a direction of the reference trajectory RL and a direction of the travel path 310.

In an example embodiment, the controller 130 may determine a displacement degree to which the robot cleaner 300 is displaced from the reference trajectory RL and control the drive part 110 to compensate for the displacement degree so that the travel path 310 coincides with the reference trajectory RL. For example, the controller 130 may control the drive part 110 to reduce the displacement distance Dd. In an example embodiment, the controller 130 controls the drive part 110 so that the displacement angle Da is close to zero when the travel path 310 coincides with the reference trajectory RL by adjusting the displacement angle Da.

Referring to FIG. 3B, in an example embodiment, the robot cleaner 300 may travel in a radial rotation mode along an arc trajectory RL2 having a predetermined radius R with reference to the reference trajectory RL1. In an example embodiment, the arc trajectory RL2 may be set with reference to the reference trajectory RL1 set in a linear shape.

In an example embodiment, in order to move toward another adjacent reference trajectory RL1, the robot cleaner 300 may travel along a shape of the arc trajectory RL2 on another adjacent reference trajectory RL1.

In an example embodiment, the actual travel path 320 may not have the shape of the set arc trajectory RL2 depending on the travel conditions around the robot cleaner 300. In an example embodiment, the controller 130 may determine the displacement degree to which the robot cleaner 300 is displace from the reference trajectory RL2 and compensate for the displacement degree based on at least one of the position and the direction of the robot cleaner 300 on the coordinate system, which are determined at a predetermined time point based on the information obtained by the sensor 120. In an example embodiment, such a compensation process may be performed in the same or similar manner as that described with reference to FIG. 3A.

In an example embodiment, when the robot cleaner 300 moves toward another adjacent reference trajectory RL1, the robot cleaner 300 may travel along the arc is in conformity with the shape of the arc trajectory RL2 tangent to another adjacent reference trajectory RL1 such that the robot cleaner 300 may travel in a direction which is opposite to the current travel direction.

In an example embodiment, the arc trajectory along which the robot cleaner 300 travels may be determined according to not only another adjacent reference trajectory RL1 but also an additional reference trajectory, such as at least one intermediate virtual trajectory RML1 that may be set between each of the adjacent reference trajectories RL1.

As described above, the robot cleaner 300 may travel along arc trajectories RL2 and RL3 having various radii based on the reference trajectory RL1 of a linear shape.

Referring to FIG. 3C, the robot cleaner 300 may travel in a direction change mode that the robot cleaner 300 rotates in place. In an example embodiment, the controller 130 may control the drive part 110 so that the robot cleaner 100 rotates by a predetermined angle with reference to a first direction 340 in place and thus rotates in a second direction 344.

In an example embodiment, although the controller 130 controls the drive part 110 so that the robot cleaner 300 rotates by a target rotational degree 350 to be oriented in the second direction 344, an actual rotational angle 352 at which the robot cleaner 300 has actually rotated may not reach the target rotational degree 350 depending on the travel conditions around the robot cleaner 300. In an example embodiment, the robot cleaner 300 may determine an orientation of the robot cleaner 300 based on the information obtained by the sensor 120. This makes it possible to determine a displacement degree to which an actual rotation direction 342 is displace from the second direction A. In an example embodiment, the controller 130 may control the drive part 110 so that the robot cleaner 300 further rotates by an angle 354 according to the displacement degree, ultimately rotates by the target rotational degree 350.

The compensation process described with reference to FIGS. 3A to 3C is merely an example illustrating a process in which the controller 130 compensates for a difference between a target driving and an actual driving. Thus, features of example embodiments may not be interpreted as being limited to the above contexts. For example, a method of compensating the displacement degree by the robot cleaner 300 may include various methods in which those skilled in the art may control the operation of the drive part 110 in order to compensate for the displacement degree.

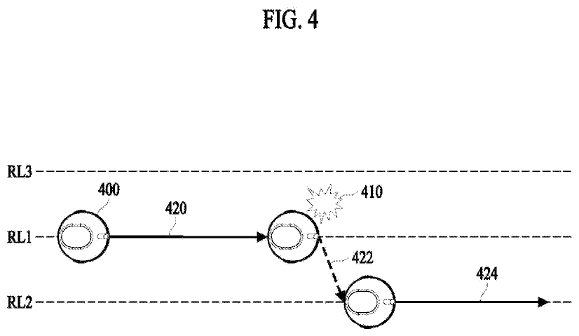

FIG. 4 illustrates a state in which a robot cleaner 400 moves over set reference trajectories. In an example embodiment, the robot cleaner 400 of FIG. 4 may correspond to the robot cleaner 100 of FIG. 1.

In an example embodiment, the robot cleaner 400 may determine whether or not a predetermined condition is satisfied (reference numeral 410). In an example embodiment, the predetermined condition may be set in advance based on various pieces of information about a travel state of the robot cleaner 400 and surrounding conditions therearound. In an example embodiment, the predetermined condition may include various conditions, such as a case in which an obstacle exists on a first reference trajectory RL1 along which the robot cleaner 400 is traveling, a case in which the robot cleaner 400 reaches the end of the reference trajectory RL1, a case in which the robot cleaner 400 needs to travel to perform another task in response to an external input signal, and the like. The description of the predetermined condition is merely an exemplary description for explaining various conditions that may trigger the movement over the reference trajectories. Thus, features of example embodiments may not be interpreted as being limited to the above contexts.

The controller 130 may control the drive part 110 so that the robot cleaner 400 moves, among the plurality of reference trajectories of linear shapes, from the first reference trajectory RL1 along which the robot cleaner 400 is traveling to the second reference trajectory RL2 (or RL3) adjacent to the first reference trajectory RL1 (reference numeral 422). In an example embodiment, a travel mode or travel pattern in which the robot cleaner 400 moves from the first reference trajectory RL1 to the second reference trajectory RL2 (or RL3) may be varied in various forms. This will be described later with various example embodiments.

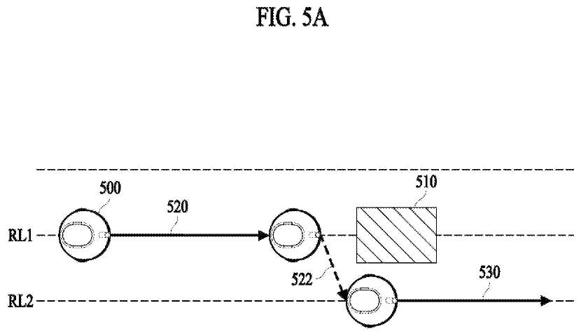

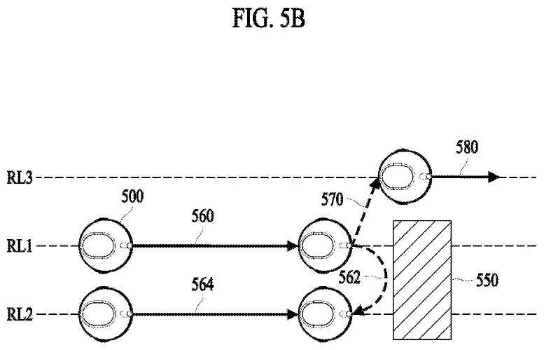

FIGS. 5A and 5B are views illustrating states in which a robot cleaner 500 moves over reference trajectories based on a predetermined condition according to an example embodiment. The robot cleaner 500 of FIGS. 5A and 5B may correspond to the robot cleaner 100 of FIG. 1.

In an example embodiment, the robot cleaner 500 may determine whether or not the predetermined condition is satisfied. The predetermined condition may be a case in which an obstacle 510 exists on the first reference trajectory RL1 along which the robot cleaner 500 is traveling. In an example embodiment, the controller 130 may determine whether or not the obstacle 510 exists on the first reference trajectory RL1 along which the robot cleaner 500 is traveling based on the information obtained by the sensor 120. In an example embodiment, when it is determined that the obstacle 510 exists on the first reference trajectory RL1 along which the robot cleaner 500 is traveling, the controller 130 may control the drive part 110 so that the robot cleaner 500 moves from the first reference trajectory RL1 along which the robot cleaner 500 is travelling to another reference trajectory RL2 adjacent to the first reference trajectory RL1 (reference numeral 522). In an example embodiment, the robot cleaner 500 may move to another reference trajectory RL2 adjacent to the first reference trajectory RL1 along which the robot cleaner 500 was travelling (reference numeral 522), and may continue to travel along another reference trajectory RL2 (reference numeral 530).

Referring to FIG. 5B, as illustrated in FIG. 5A, the controller 130 may determine whether or not an obstacle 550 exists on the first reference trajectory RL1 along which the robot cleaner 500 is traveling based on the information obtained by the sensor 120. In an example embodiment, when it is determined that the obstacle 550 exists on the first reference trajectory RL1, the robot cleaner 500 may move to another reference trajectory RL2 (or RL3) adjacent to the first reference trajectory RL1 along which the robot cleaner 500 is currently travelling, and may continue to travel along another reference trajectory RL2 (or RL3) (reference numeral 564 or 580).

In an example embodiment, the controller 130 may determine whether or not the obstacle 550 also exists on the second reference trajectory RL2 based on the information obtained by the sensor 120. In an example embodiment, when it is determined that the obstacle 550 also exists on the second reference trajectory RL2 along which the robot cleaner 500 tries to move from the first reference trajectory RL1, the controller 130 may the drive part 110 so that the robot cleaner 500 moves to the second reference trajectory RL2 and simultaneously change a travel direction thereof to travel along the second reference trajectory RL2 (reference numeral 564). That is, even though the obstacle 550 exists on the first reference trajectory RL1 along which the robot cleaner 500 is traveling and the robot cleaner 500 has moved to the second reference trajectory RL2, when the obstacle 550 still exists on the second reference trajectory RL2, the robot cleaner 500 may travel in a direction which is opposite to the direction in which the robot cleaner 500 was traveling, that is, a direction away from the obstacle 550.

In an example embodiment, when it is determined that the obstacle 550 exists on the first reference trajectory RL1, the robot cleaner 500 may move to the second reference trajectory RL3 on which the obstacle 550 is determined to not exist, among other reference trajectories RL2 and RL3 adjacent to the first reference trajectory RL1 along which the robot cleaner 500 is currently travelling, and may travel along the second reference trajectory RL3 (reference numeral 580). In an example embodiment, when the obstacle 550 exists on the reference trajectory RL1 along which the robot cleaner 500 is travelling, the controller 130 may control the drive part 110 so that the robot cleaner 500 moves to the second reference trajectory RL3 on which the obstacle 550 not exists while maintaining the travel direction thereof and travels along the second reference trajectory RL3 (reference numeral 580).

In an example embodiment, a pattern in which the robot cleaner 500 moves from the first reference trajectory to the second reference trajectory may include at least one of a linear pattern and an arc pattern. The pattern in which the robot cleaner 500 moves over the reference trajectories and travels along the respective reference trajectory will be described later with various example embodiments.

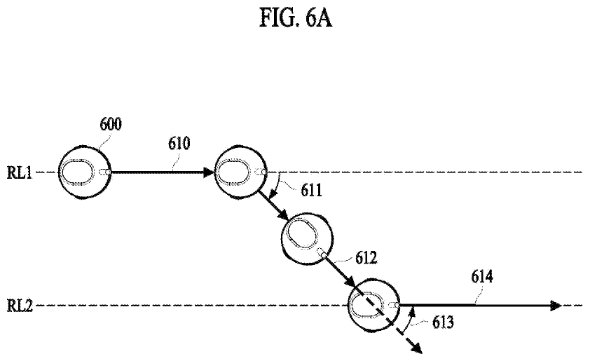

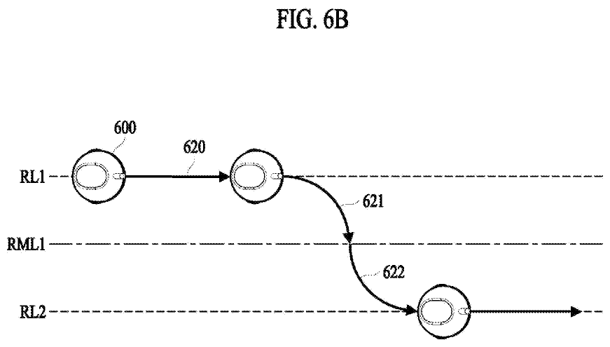

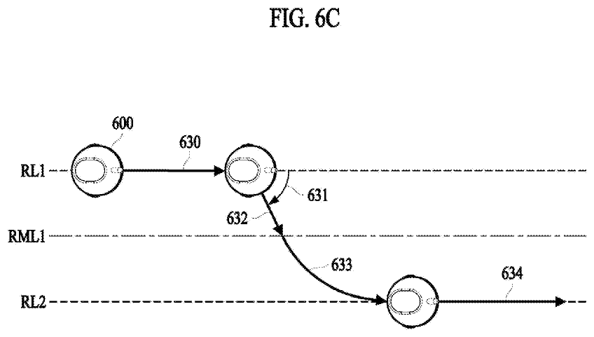

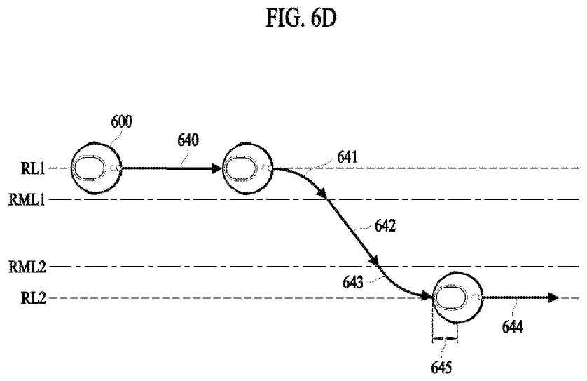

FIGS. 6A to 6D are views illustrating states in which a robot cleaner 600 travels along reference trajectories and an intermediate reference trajectory according to an example embodiment. The robot cleaner 600 of FIGS. 6A to 6D may correspond to the robot cleaner 100 of FIG. 1.

Referring to FIG. 6A, in an example embodiment, the robot cleaner 600 may be determined so as to move from a first reference trajectory RL1 along the robot cleaner 600 linearly travels (reference numeral 610) to a second reference trajectory RL2 adjacent to the first reference trajectory RL1. In an example embodiment, the robot cleaner 600 that is traveling (reference numeral 610) may rotate toward the second reference trajectory RL2 in place by a change in direction (reference numeral 611) so as to move to the second reference trajectory RL2. In an example embodiment, the robot cleaner 600 may move toward the second reference trajectory RL2 in that rotation direction. In an example embodiment, an operation of moving toward the second reference trajectory RL2 may be performed through a combination of at least one of a linear travel mode, a radial rotation mode, and a direction change mode. In an example embodiment, in a case in which the robot cleaner 600 travels over the first reference trajectory RL1 and the second reference trajectory RL2 in the linear travel mode, the robot cleaner 600 may rapidly move from the first reference trajectory RL1 to the second reference trajectory RL2 and vice-versa in a short period of time. Further, in a case in which the robot cleaner 600 travels over the first reference trajectory and the second reference trajectory RL2 in the radial rotation mode, the robot cleaner 600 may move from the first reference trajectory RL1 to the second reference trajectory RL2 and vice-versa while cleaning a relatively large area.

In an example embodiment, in a case in which the robot cleaner 600 moves from the first reference trajectory RL1 to the second reference trajectory RL2 in the linear travel mode 612, the robot cleaner 600 that reaches the second reference trajectory RL2 may be aligned in a direction coinciding with that of the second reference trajectory RL2 in the direction change mode 613 on the second reference trajectory RL2, and subsequently may travel along the second reference trajectory RL2 (reference numeral 614).

Referring to FIG. 6B, the robot cleaner 600 may further have at least one intermediate reference trajectory RML1 set between the first reference trajectory RL1 and the second reference trajectory RL2. In an example embodiment, the controller 130 may determine a pattern in which the robot cleaner 600 travel via the at least one intermediate reference trajectory RML1 when moving over the first reference trajectory RL1 and the second reference trajectory RL2.

In an example embodiment, the robot cleaner 600 may travel in the radial rotation mode to move from the first reference trajectory RL1 to the second reference trajectory RL2. In an example embodiment, the pattern in which the robot cleaner 600 travels in the radial rotation mode to move from the first reference trajectory RL1 to the second reference trajectory RL2 may have plural types of patterns. Such a travel pattern may be changed with reference to a time point passing through the intermediate reference trajectory RML1. Referring to FIG. 6B, the controller 130 may control the drive part 110 so that the robot cleaner 600, which is traveling along the first reference trajectory RL1 (reference numeral 620), travels in a first radial rotation mode 621 and subsequently, travels in a second radial rotation mode 622 at a time pint at which the robot cleaner 600 passes through the intermediate reference trajectory RML1. In an example embodiment, the first radial rotation mode 621 and the second radial rotation mode 622 may be understood to be different travel patterns in terms of various parameters, such as a radius range, a radius center position, a curvature, and the like.

Referring to FIG. 6C, in an example embodiment, the robot cleaner 600, which is travelling (reference numeral 630), may rotate toward the second reference trajectory RL2 in place in the direction change mode 631 and move to the second reference trajectory RL2. In an example embodiment, the robot cleaner 600 may move toward the second reference trajectory RL2 in that rotation direction. In an example embodiment, the robot cleaner 600 may move from the first reference trajectory RL1 to the second reference trajectory RL2 in the radial rotation mode 633. In an example embodiment, when the robot cleaner 600 reaches the second reference trajectory RL2 in the radial rotation mode 633, a direction of the second reference trajectory RL2 and a travel direction of the robot cleaner 600 may already be arranged to each other at the time of reaching. This eliminates the need to drive in the direction change mode 613. That is, the robot cleaner 600 which reached the second reference trajectory RL2 while travelling in the radial rotation mode 633, may continuously change the travel pattern thereof into the linear travel mode 634 to travel along the second reference trajectory RL2.

Referring to FIG. 6D, in an example embodiment, the robot cleaner 600 may travel in the linear travel mode and the radial rotation mode to move from the first reference trajectory RL1 to the second reference trajectory RL2. In an example embodiment, the pattern in which the robot cleaner 600 travels in the radial rotation mode to move from the first reference trajectory RL1 to the second reference trajectory RL2 may have plural types of patterns. Such a travel pattern may be changed with reference to a time point at which the robot cleaner 600 passes through a plurality of intermediate reference trajectories RML1 and RML2. Referring to FIG. 6D, the robot cleaner 600 travels in the linear travel mode 640 along the first reference trajectory RL1 and subsequently, travels in the first radial rotation mode 641 to be deviated from the first reference trajectory RL1. In an example embodiment, the robot cleaner 600 may change the travel pattern thereof into the linear travel mode 642 at a time point at which the robot cleaner 600 passes the first intermediate reference trajectory RML1 while travelling in the first radial rotation mode 641. In an example embodiment, the robot cleaner 600 may change the travel pattern thereof into the second radial rotation mode 643 at a time point at which the robot cleaner 600 passes through the second intermediate reference trajectory RML2 while traveling in the linear travel mode 642. In an example embodiment, the robot cleaner 600 may enter on the second reference trajectory RL2 in the second radial rotation mode 643 and continue to travel along the second reference trajectory RL2 in the linear travel mode 644.

In an example embodiment, referring to FIGS. 6B and 6D, at least one intermediate reference trajectory may be used. The travel pattern may be variously changed by setting a large number of intermediate reference trajectories. The controller 130 may control the drive part 110 so that the robot cleaner 600 efficiently moves over the reference trajectories RL1 and RL2 in consideration of characteristics of each travel pattern. For example, the linear travel mode 642 may be used for moving over the reference trajectories. In an example embodiment, in FIG. 6D, the linear travel mode 642 may further be used compared with FIG. 6B so that the robot cleaner 600 may reach the second reference trajectory RL2 at a relatively more advanced position. In an example embodiment, in the case of the linear travel mode, the cleaning area during the travel of the robot cleaner may be narrower than that in the radial rotation mode, but the robot cleaner is possible to move in the cleaning area in a short period of time. Meanwhile, in the case of the radial rotation mode, the robot cleaner may travel while cleaning a restively large area in the course of moving to a target point, but the time required to reach the target point may be longer than that in the linear travel mode. The controller 130 may determine an optimal travel pattern by combining various travel patterns including the linear travel mode, the radial rotation mode, and the direction change mode based on information about the environment around the cleaning area, and may control the drive part 110 so that the robot cleaner 600 travels in the determined optimal travel pattern.

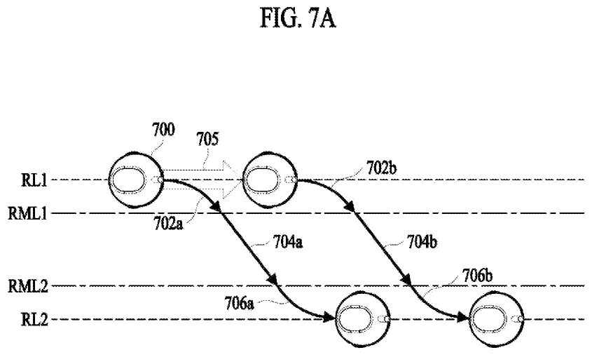

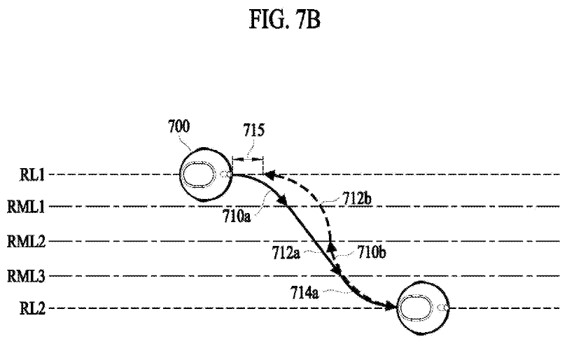

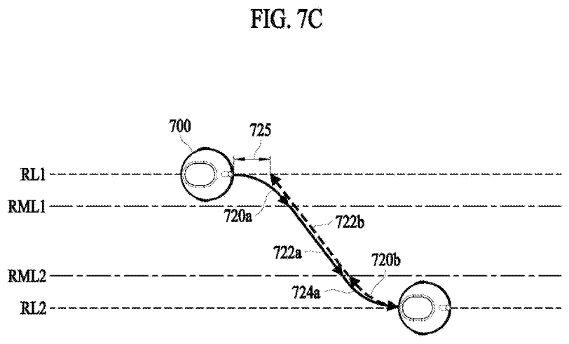

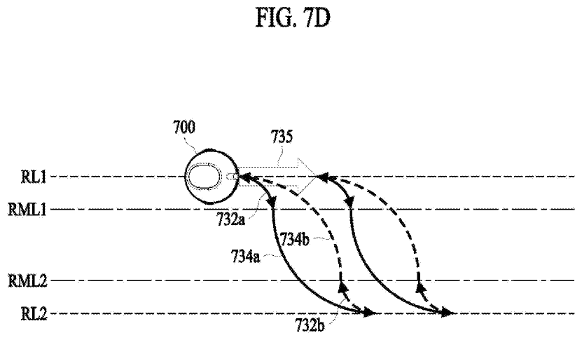

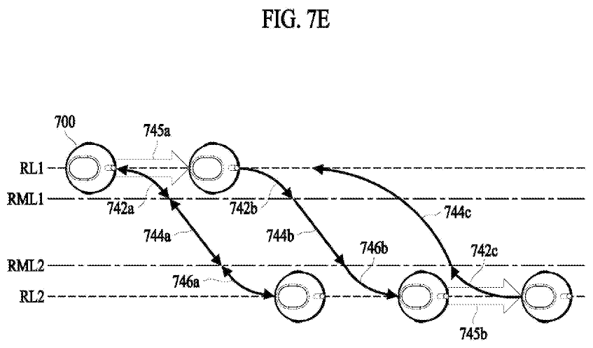

FIGS. 7A to 7F are views illustrating states in which a robot cleaner 700 travels in an reciprocate travel mode according to an example embodiment. The robot cleaner 700 of FIGS. 7A to 7F may correspond to the robot cleaner 100 of FIG. 1.

Referring to FIG. 7A, in an example embodiment, the robot cleaner 700 may use various travel patterns (for example, linear travel modes 704a and 704b, and radial rotation schemes 702a, 702b, 706a and 706b) to move from the first reference trajectory RL1 to the second reference trajectory RL2. In an example embodiment, the controller 130 of the robot cleaner 700 may control the drive part 110 so that the robot cleaner 700 travels in a reciprocate travel mode of moving from the first reference trajectory RL1 to the second reference trajectory RL2 and then returning to the first reference trajectory RL1.

In an example embodiment, a pattern in which the robot cleaner travels in the reciprocate travel mode over the first reference trajectory RL1 and the second reference trajectory RL2 may be changed in various forms.

In an example embodiment, positions and directions of the robot cleaner 700 on at least one of the first reference trajectory RL1 and the second reference trajectory RL2 before and after travelling in the reciprocate travel mode may be the same. Referring to FIG. 7A, in an example embodiment, a pattern in which the robot cleaner 700 moves from the first reference trajectory RL1 to the second reference trajectory RL2 and a pattern in which the robot cleaner 700 returns the first reference trajectory RL1 from the second reference trajectory RL2 may be the same. In an example embodiment, the controller 130 may control the drive part 110 such that the robot cleaner 700 moves backward from the second reference trajectory RL2 to the first reference trajectory RL1 in a travel pattern that is opposite the forward travel pattern from the first reference trajectory RL1 to the second reference trajectory RL2, thus returning the first reference trajectory RL1. That is, positions and directions of the robot cleaner 700 on the first reference trajectory RL1 after travelling in the reciprocate travel mode may be the same. In an example embodiment, the controller 130 may determine whether or not positions and directions of the robot cleaner 700 on the reference trajectory RL1 after travelling in the reciprocate travel mode are the same. When displacement occurs in the positions and the directions on the reference trajectory RL1 before and after travelling in the reciprocate travel mode, the controller 130 may determine such a displacement degree and control the drive part 110 to perform a compensation process of compensating the displacement degree.

According to an example embodiment, the controller 130 may control the drive part 110 so that robot cleaner travels by a predetermined distance on the first reference trajectory RL1 and the second reference trajectory RL2 while travelling in the reciprocate travel mode. In an example embodiment, the positions of the robot cleaner 700 on the first reference trajectory RL1 after travelling in the reciprocate travel mode become equal to each other. Thus, after travelling in the reciprocate travel mode, the robot cleaner 700 may move along the first reference trajectory RL1 in the linear travel mode 705 to move forward along the first reference trajectory RL1 In an example embodiment, the robot cleaner 700, which moved forward by a predetermined distance in the linear travel mode 705 after travelling in the reciprocate travel mode, may travel in the reciprocate travel mode again. Accordingly, the robot cleaner 700 may perform cleaning while moving forward along both the first reference trajectory RL1 and the second reference trajectory RL2.

Referring to FIG. 7B, in an example embodiment, the pattern in which the robot cleaner 700 moves from the first reference trajectory RL1 to the second reference trajectory RL2 and the pattern in which the robot cleaner 700 returns from the second reference trajectory RL2 to the first reference trajectory RL1 may be different from each other. For example, the controller 130 may control the drive part 110 so that, when moving from the first reference trajectory RL1 to the second reference trajectory RL2, the robot cleaner 700 travels in a pattern in which a linear travel mode 712a and a radial rotation mode 710a are combined with each other, and when returning from the second reference trajectory RL2 to the first reference trajectory RL1, the robot cleaner 700 travels in a pattern in which merely radial rotation modes 710b and 712b are used. In an example embodiment, the controller 130 may change the travel pattern via a plurality of intermediate reference trajectories (for example, RML1, RML2 and RML3) so that the pattern in which the robot cleaner 700 moves from the first reference trajectory RL1 to the second reference trajectory RL2 and the pattern in which the robot cleaner 700 returns from the second reference trajectory RL2 to the first reference trajectory RL1 are set to be different from each other.

In an example embodiment, the controller 130 may control the drive part 110 so that at least one of positions and directions of the robot cleaner 700 on the first reference trajectory RL1 when travelling in the reciprocate travel mode in different patterns are different from each other.

Referring to FIG. 7B, in an example embodiment, the controller 130 may set the pattern in which the robot cleaner 700 moves from the first reference trajectory RL1 to the second reference trajectory RL2 and the pattern in which the robot cleaner 700 returns from the second reference trajectory RL2 to the first reference trajectory RL1 to be different from each other. Thus, the controller 130 may control the drive part 110 so that the robot cleaner 700 moves forward on the first reference trajectory RL1 by a predetermined distance 715 after travelling in the reciprocate travel mode.

In an example embodiment, the controller 130 may set a position of the robot cleaner 700 on the intermediate reference trajectory in the course of moving from the first reference trajectory RL1 to the second reference trajectory RL2 and a position of the robot cleaner 700 on the intermediate reference trajectory in the course of returning from the second reference trajectory RL2 to the reference trajectory RL1 to be different from each other when travelling in the reciprocate travel mode. Referring to FIG. 7B, the intermediate reference trajectories RML1 and RML3 considered in the course of moving from the first reference trajectory RL1 to the second reference trajectory RL2 when travelling in the reciprocate travel mode and the intermediate reference trajectory RML2 considered in the course of moving from the first reference trajectory RL1 to the second reference trajectory RL2 when travelling in the reciprocate travel mode may be different from each other in terms of at least one of a position and number thereof.

Referring to FIG. 7C, in an example embodiment, the controller 130 may set the pattern in which the robot cleaner 700 moves from the first reference trajectory RL1 to the second reference trajectory RL2 and the pattern in which the robot cleaner 700 returns from the second reference trajectory RL2 to the first reference trajectory RL1 to be different from each other. Thus, the controller 130 may control the drive part 110 so that the robot cleaner 700 moves forward on the first reference trajectory RL1 by a predetermined distance 725 after travelling in the reciprocate travel mode, and a direction of the robot cleaner 700 before travelling in the reciprocate travel mode and a direction of the robot cleaner 700 after travelling in the reciprocate travel mode are different from each other.

Referring to FIG. 7C, the controller 130 may control the drive part 110 so that, when moving from the first reference trajectory RL1 to the second reference trajectory RL2, the robot cleaner 700 moves in a pattern in which a linear travel mode 722a and radial rotation mode 720a and 724a are combined with each other, and when returning from the second reference trajectory RL2 to the first reference trajectory RL1, the robot cleaner 700 moves in a pattern in which a radial rotation mode 720b and a linear travel mode 722b are used. In an example embodiment, the robot cleaner 700 would have travelled in the linear travel mode 722b at the time of returning the first reference trajectory RL1. Accordingly, the direction of the robot cleaner 700 may differ from the direction of the first reference trajectory RL1. In an example embodiment, the robot cleaner 700 may travel in the direction change mode on the first reference trajectory RL1 in order to coincide the direction of the first reference trajectory RL1 with the direction of the robot cleaner 700.

Referring to FIG. 7D, in an example embodiment, the pattern in which the robot cleaner 700 moves from the first reference trajectory RL1 to the second reference trajectory RL2 and the pattern in which the robot cleaner 700 returns from the second reference trajectory RL2 to the first reference trajectory RL1 may be different from each other. In an example embodiment, the controller 130 may control the drive part 110 so that the robot cleaner 700 moves backward in patterns 732b and 734b different from patterns 732a and 734a followed when moving forward from the first reference trajectory RL1 to the second reference trajectory RL2, and returns from the second reference trajectory RL2 to the first reference trajectory RL1. That is, the controller 130 may control the drive part 110 so that positions and directions of the robot cleaner 700 on the first reference trajectory RL1 are identical to each other even after travelling in the forward travel mode and in the backward travel mode in different patterns. In an example embodiment, the robot cleaner 700 may return to the same position on the first reference trajectory RL1 while travelling in the reciprocate travel mode, and then may travel along the first reference trajectory RL1 in a linear travel mode 735. As described with reference to FIG. 7A, when displacement occurs in positions and directions of the robot cleaner 700 on the first reference trajectory RL1 before and after travelling in the reciprocate travel mode, the controller 130 may control the drive part 110 to perform a process of determining and compensating for such a displacement degree.

In an example embodiment, the controller 130 may control the drive part 110 so that the robot cleaner 700 travels in a combined pattern including the pattern in which the robot cleaner 700 moves from the first reference trajectory RL1 to the second reference trajectory RL2 and the pattern in which the robot cleaner 700 returns from the second reference trajectory RL2 to the first reference trajectory RL1, which are identical to or different from each other. Referring to FIG. 7E, the controller 130 may control the drive part 110 so that the robot cleaner 700 moves backward in the same pattern as the travel pattern followed when moving in the forward travel mode from the first reference trajectory RL1 to the second reference trajectory RL2, and travels in reciprocate travel patterns 742a, 744a an 746a.

In an example embodiment, the controller 130 may control the drive part 110 so that the robot cleaner 700 travels in a linear travel mode 745a on the first reference trajectory RL1.

In an example embodiment, the controller 130 may control the drive part 110 so that, after travelling in the linear travel mode 745a, the robot cleaner 700 travels in a state in which the travel pattern in which the robot cleaner 700 moves from the first reference trajectory RL1 to the second reference trajectory RL2 and the travel pattern in which the robot cleaner 700 returns from the second reference trajectory RL2 to the first reference trajectory RL1 are different from each other. For example, the travel pattern in which the robot cleaner 700 moves from the first reference trajectory RL1 to the second reference trajectory RL2 may include radial rotation patterns 742b and 746b, and a linear travel pattern 744b, while the travel pattern in which the robot cleaner 700 returns from the second reference trajectory RL2 to the first reference trajectory RL1 may include radial rotation patterns 742c and 744c.

In an example embodiment, the controller 130 may determine that the operation of traveling along the second reference trajectory RL2 is included in the operation of travelling in the reciprocate travel mode over the first reference trajectory RL1 and the second reference trajectory RL2. Referring to FIG. 7E, in an example embodiment, the controller 130 may control the drive part 110 so that the robot cleaner 700 moves from the first reference trajectory RL1 to the second reference trajectory RL2, moves by a predetermined distance in a linear travel mode 745b on the second reference trajectory RL2, and then return to the first reference trajectory RL1 from the second reference trajectory RL2.

In an example embodiment, a position on the first reference trajectory RL1 of the robot cleaner 700 which has travelled by the predetermined distance in the linear travel mode 745b and subsequently returned to the first reference trajectory RL1 from the second reference trajectory RL2 may be identical to a position on the first reference trajectory RL1 of the robot cleaner 700 before travelling in the reciprocate travel mode. In an example embodiment, the robot cleaner 700 which has returned to the same position on the first reference trajectory RL1 may move forward in the linear travel mode.

In an example embodiment, a position on the first reference trajectory RL1 of the robot cleaner 700 which has travelled by the predetermined distance in the linear travel mode 745b and subsequently returned to the first reference trajectory RL1 from the second reference trajectory RL2 may be different from a position on the first reference trajectory RL1 of the robot cleaner 700 before travelling in the reciprocate travel mode. In an example embodiment, the robot cleaner 700 which has returned to the different position on the first reference trajectory RL1 may also move forward in the linear travel mode.

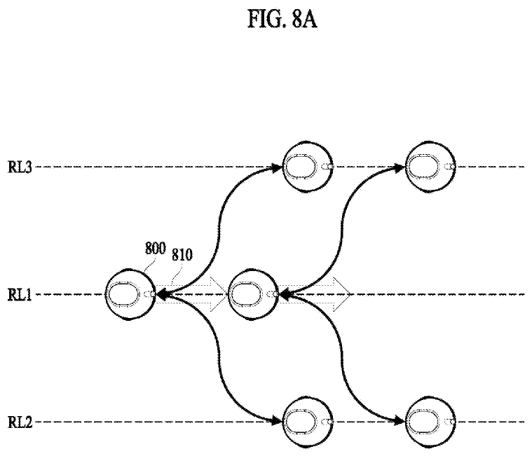

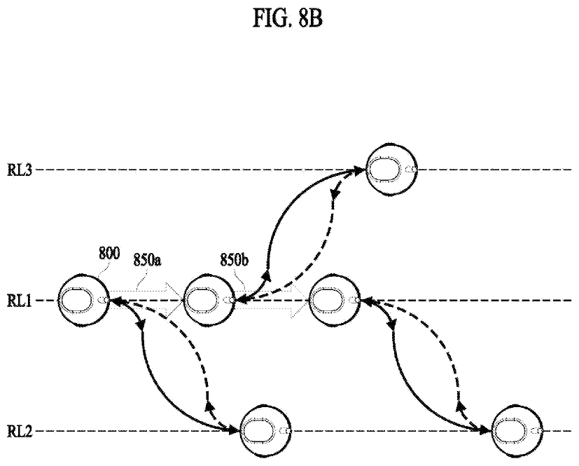

FIGS. 8A and 8B are views illustrating states in which the robot cleaner 800 travels in a reciprocate travel mode along a first reference trajectory, a second reference trajectory, and a third reference trajectory according to an example embodiment. The robot cleaner 800 of FIGS. 8A and 8B may correspond to the robot cleaner 100 of FIG. 1.

Referring to FIG. 8A, the controller 130 may set a third reference trajectory RL3 defined in an opposite direction of a second reference trajectory RL2 with reference to a first reference trajectory RL1.

In an example embodiment, the second reference trajectory RL2 and the third reference trajectory RL3 may be spaced apart from the first reference trajectory RL1 by the same distance.

In an example embodiment, the second reference trajectory RL2 and the third reference trajectory RL3 may be spaced apart from the first reference trajectory RL1 by different distances. In an example embodiment, the controller 130 may variously set distances between the reference trajectories based on various pieces of information such as conditions of a cleaning area, a driving performance of the robot cleaner 800, and the like.

In an example embodiment, the robot cleaner 800 may be traveling along the first reference trajectory RL1. In an example embodiment, the controller 130 may control the drive part 110 so that the robot cleaner 800 moves to the second reference trajectory RL2 and the third reference trajectory RL3 which are adjacent to the first reference trajectory RL1 based on whether or not a predetermined condition is satisfied. In an example embodiment, the controller 130 may control the drive part 110 so that the robot cleaner 800 travels in a first reciprocate travel mode over the first reference trajectory RL1 and the second reference trajectory RL2 and subsequently, travels in a second reciprocate travel mode over the first reference trajectory RL1 and the third reference trajectory RL3.

An operation of travelling in each of the first reciprocate travel mode and the second reciprocate travel mode may be implemented using features described in various example embodiments of the present disclosure, and detailed descriptions thereof will be omitted. Accordingly, as examples of the first reciprocate travel mode and the second reciprocate travel mode, features of the first reciprocate travel mode and the second reciprocate travel mode may not be interpreted as being limited to the contents illustrated in FIGS. 8A and 8B.

In an example embodiment, the controller 130 may control the drive part 110 so that the first reciprocate travel mode and the second reciprocate travel mode are performed in an alternate manner.

In an example embodiment, the controller 130 may control the drive part 110 so that a position and direction of the robot cleaner 800 on the first reference trajectory RL1 after travelling in the first reciprocate travel mode and the second reciprocate travel mode are the same as those before travelling in the first reciprocate travel mode and the second reciprocate travel mode. Referring to FIG. 8A, the robot cleaner 800 may be positioned at the same position on the first reference trajectory RL1 before and after travelling in the first reciprocate travel mode and the second reciprocate travel mode. In an example embodiment, the controller 130 may control the drive part 110 so that the robot cleaner 800 returns to the first reference trajectory RL1 by travelling in the first reciprocate travel mode and the second reciprocate travel mode, and then travels along the first reference trajectory RL1 in a linear travel mode 810. In an example embodiment, after travelling in the first reciprocate travel mode and the second reciprocate travel mode, the robot cleaner 800 which has moved forward by a predetermined distance in the linear travel mode 810, may repeatedly travel in the first reciprocate travel mode and the second reciprocate travel mode again.

In an example embodiment, the controller 130 may control the drive part 110 so that a position and a direction of the robot cleaner 800 on the first reference trajectory RL1 after travelling in at least one of the first reciprocate travel mode and the second reciprocate travel mode are different from those before travelling in the first reciprocate travel mode and the second reciprocate travel mode. Referring to FIG. 8B, in an example embodiment, the robot cleaner 800 may travel in the first reciprocate travel mode and then travel along the first reference trajectory RL1 by a predetermined distance in a linear travel mode 850a. In an example embodiment, the robot cleaner 800 which has travelled along the first reference trajectory RL1 by the predetermined distance in the linear travel mode 850a may travel in the second reciprocate travel mode. In an example embodiment, the robot cleaner 800 may travel in the second reciprocate travel mode and then travel along the first reference trajectory RL1 by a predetermined distance in a linear travel mode 850b. In an example embodiment, the robot cleaner 800 which has travelled along the first reference trajectory RL1 by the predetermined distance in the linear travel mode 850b may travel in the first reciprocate travel mode (or the second reciprocate travel mode) again.

In an example embodiment, the forward travel pattern and the backward travel pattern performed by the robot cleaner 800 in each of the first reciprocate travel mode and the second reciprocate travel mode may be different from each other.

In an example embodiment, patterns of the first reciprocate travel mode and the second reciprocate travel mode may be different from each other.

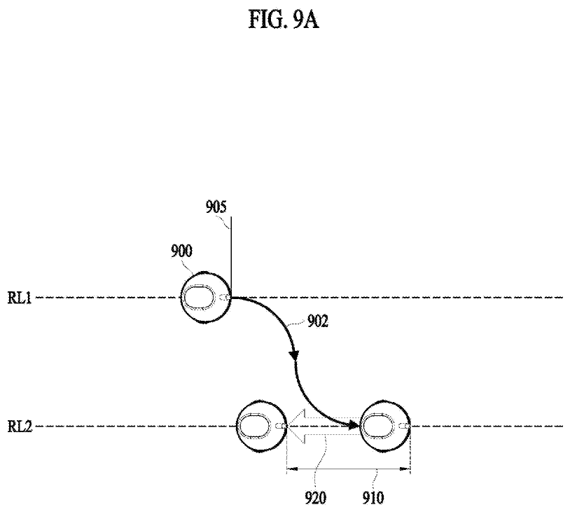

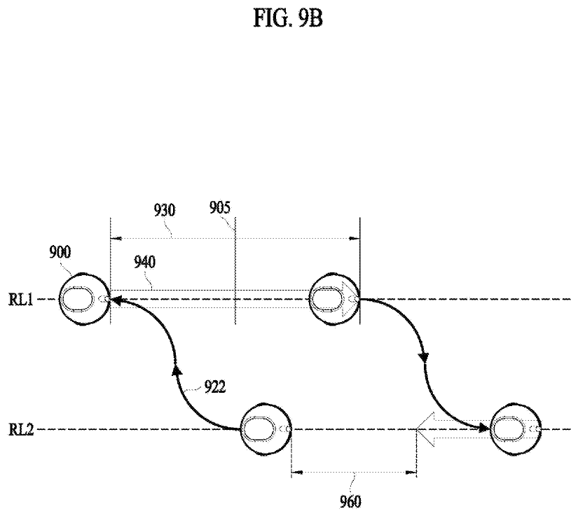

FIGS. 9A and 9B are views illustrating states in which a robot cleaner 900 performs cleaning through an operation of travelling in a reciprocate travel mode over reference trajectories and an operation of moving forward or backward along reference trajectories according to an example embodiment. The robot cleaner 900 of FIGS. 9A and 9B may correspond to the robot cleaner 100 of FIG. 1.

In an example embodiment, the controller 130 may set a travel cycle by combining an operation of traveling in a linear travel mode along at least one of the plurality of reference trajectories RL1 and RL2 and an operation of moving over the plurality of reference trajectories RL1 and RL2. In an example embodiment, the travel cycle may be defined as a cycle in which the robot cleaner 900 repeatedly performs an operation of moving forward along the first reference trajectory RL1. Therefore, positions and directions of the robot cleaner 900 on the first reference trajectory RL1 at the time points at which the travel cycle starts and ends may not be identical to each other.

Referring to FIG. 9A, in an example embodiment, the robot cleaner 900 may start the travel cycle while being located on the first reference trajectory RL1. In an example embodiment, the robot cleaner 900 may move to the second reference trajectory RL2 adjacent to the first reference trajectory RL1 (reference numeral 902).

In an example embodiment, the robot cleaner 900 which has moved to the second reference trajectory RL2 may move in a linear travel mode 920 along the second reference trajectory RL2. Referring to FIG. 9A, in an example embodiment, the robot cleaner 900 may move to the second reference trajectory RL2 and then move backward by a predetermined distance 910 in the linear travel mode 920.

Referring to FIG. 9B, in an example embodiment, the robot cleaner 900 which has moved backward by the predetermined distance 910 may move from the second reference trajectory RL2 to the first reference trajectory RL1 (reference numeral 922). In an example embodiment, a position of the robot cleaner 900 which has moved to the first reference trajectory RL1 (reference numeral 922) may be different from a position 905 of the robot cleaner 900 before moving to the second reference trajectory RL2 (reference numeral 902). In an example embodiment, such a position difference may be caused due to various factors, such as a travel pattern of the robot cleaner 900 on the second reference trajectory RL2, a travel pattern of the robot cleaner 900 over the first reference trajectory RL1 and the second reference trajectory RL2, and the like.

In an example embodiment, the robot cleaner 900 may move by a predetermined distance 930 along the first reference trajectory RL1 in the linear travel mode (reference numeral 940).

In an example embodiment, assuming that a starting time of the travel cycle is a time point at which the robot cleaner 900 moves from the first reference trajectory RL1 to the second reference trajectory RL2 (reference numeral 902), the controller 130 may determine that the travel cycle of the robot cleaner 900 ends when the robot cleaner 900 has moved the predetermined distance 930 along the first reference trajectory RL1 (reference numeral 940). That is, the controller 130 may control the drive part 110 so that the robot cleaner 900 moves forward in a predetermined direction by repeating the travel cycle in which the robot cleaner 900 starts to move from the first reference trajectory RL1 to the second reference trajectory RL2 (reference numeral 902) and moves by the predetermined distance 930 (reference numeral 940). In an example embodiment, a position of the robot cleaner 900 on the first reference trajectory RL1 at the end of the travel cycle may be a position displaced by a predetermined distance 970 compared to the position 905 at the start of the travel cycle. In an example embodiment, the controller 130 may control the drive part 110 to repeatedly perform the travel cycle so that the robot cleaner 900 performs cleaning while moving forward in a predetermined direction.

In an example embodiment, the robot cleaner 100 may perform cleaning through various functions such as an autonomous driving function that travels by itself rather than moving by an external force by a user. In an example embodiment, the controller 130 may create a map through various algorithms in the art, such as a dead reckoning, a simultaneous localization and map-building (SLAM) and the like based on various pieces of information obtained by the sensor 120 and use the map for traveling. In an example embodiment, the robot cleaner 100 may further include a separate sensor or processor for executing such algorithms.

In an example embodiment, the robot cleaner 100 may further include a computer-readable recording medium or memory (not illustrated) that records programs for executing the various modes described above. A power line communication method of the robot cleaner 100 according to the present disclosure described above may be provided by being recorded in the computer-readable recording medium that records a program to be executed by a computer.

The methods of the present disclosure may be executed through software. When executed through the software, the constituent means of the present disclosure are code segments that perform necessary tasks. The program or code segments may be stored on a processor-readable medium.

The computer-readable recording medium may include all types of recording mediums in which data readable by a computer system is stored. Examples of the computer-readable recording medium may include a read-only memory (ROM), a random access memory (RAM), a compact disk-read only memory (CD-ROM), a digital versatile disk (DVD)±ROM, a magnetic tape, a floppy disk, a hard disk, an optical data storing device, and the like. Further, the computer-readable recording medium may be distributed over network coupled computer systems, and thus, the computer-readable code may be stored and executed in a distributed fashion.

The present disclosure described above is capable of various substitutions, modifications and changes within the scope without departing from the technical spirit of the present disclosure for those of ordinary skill in the art to which the present disclosure pertains. It is not limited by the drawings. Further, example embodiments described in the present disclosure are not limitedly applicable, but all or part of each example embodiment may be selectively combined so that various modifications may be made.

Various substitutions, modification, and variations may be made to the contents described in the present disclosure by those skilled in the art to which the present disclosure pertains without departing from the technical spirit and scope of the present disclosure. Therefore, the present disclosure is not limited to the above-described example embodiments and those described with reference to the accompanying drawings.

1. A robot cleaner, comprising:
a drive part configured to apply a driving force required to drive the robot cleaner;
a sensor configured to obtain at least one of information about a travel state of the robot cleaner and information about surroundings of the robot cleaner; and
a controller configured to determine reference trajectories on a coordinate system of a cleaning area, and to compensate for a degree to which the robot cleaner is spaced apart from the reference trajectories based on at least one of a position and a direction of the robot cleaner, which are determined based on the at least one information obtained by the sensor.

2. The robot cleaner of claim 1, wherein the sensor includes:
a gyroscope configured to obtain acceleration information of the robot cleaner;
a movement distance sensor configured to obtain information about a movement distance of the robot cleaner; and
an obstacle sensor configured to sense an obstacle in the cleaning area.

3. The robot cleaner of claim 1, wherein the controller is configured to determine the reference trajectories composed of a plurality of linear trajectories on the cleaning area.

4. The robot cleaner of claim 1, wherein the controller is configured to control the drive part to drive the robot cleaner in at least one of modes including a linear movement, a radial rotation and a change in direction based on the reference trajectories.

5. The robot cleaner of claim 1, wherein, when a predetermined condition is determined to be satisfied, the controller is configured to control the drive part such that robot cleaner travels along a second reference trajectory adjacent to a first reference trajectory along which the robot cleaner is traveling among the reference trajectories.

6. The robot cleaner of claim 5, wherein the controller is configured to:
determine, the predetermined condition, whether or not an obstacle exists on the first reference trajectory along which the robot cleaner is traveling among the reference trajectories based on the at least one information obtained by the sensor; and
when the obstacle is determined to exist on the first reference trajectory, control the drive part such that the robot cleaner travels on the second reference trajectory adjacent to the first reference trajectory.

7. The robot cleaner of claim 6, wherein the controller is configured to:
when the robot cleaner is determined to be entered the second reference trajectory, determine whether or not the obstacle exists on the second reference trajectory; and
when the obstacle is determined to not exist on the second reference trajectory, control the drive part such that the robot cleaner travels in a direction in which the robot cleaner is traveling on the first reference trajectory.

8. The robot cleaner of claim 7, wherein the controller is configured to:
when the obstacle is determined to exist on the second reference trajectory, control the drive part such that the robot cleaner travels in a opposite direction which is opposite to the direction in which the robot cleaner is traveling on the first reference trajectory.

9. The robot cleaner of claim 5, wherein a pattern in which the robot cleaner moves from the first reference trajectory to the second reference trajectory includes at least one of a linear pattern and an arc pattern.

10. The robot cleaner of claim 5, wherein the controller is configured to:
set at least one intermediate reference trajectory between the first reference trajectory and the second reference trajectory; and
change a pattern in which the robot cleaner moves from the first reference trajectory to the second reference trajectory when the robot cleaner passes along the at least one intermediate reference trajectory.

11. The robot cleaner of claim 5, wherein the controller is configured to control the drive part such that the robot cleaner travels in a reciprocate travel mode over the first reference trajectory and the second reference trajectory according to the predetermined condition.

12. The robot cleaner of claim 11, wherein the controller is configured to, when travelling in the reciprocate travel mode, set a position of the intermediate reference trajectory while the robot cleaner moves from the first reference trajectory to the second reference trajectory, and a position of the intermediate reference trajectory while the robot cleaner returns from the second reference trajectory to the first reference trajectory, to be different from each other.

13. The robot cleaner of claim 11, wherein the controller is configured to control the drive part such that a position and a direction of the robot cleaner on at least one of the first reference trajectory and the second reference trajectory before and after travelling in the reciprocate travel mode are identical to each other.

14. The robot cleaner of claim 11, wherein the controller is configured to control the drive part such that at least one of a position and a direction of the robot cleaner on the first reference trajectory and the second reference trajectory before and after travelling in the reciprocate travel mode are different from each other.

15. The robot cleaner of claim 11, wherein the controller is configured to control the drive part such that the robot cleaner travels by a predetermined distance on the first reference trajectory and the second reference trajectory while travelling in the reciprocate travel mode.

16. The robot cleaner of claim 11, wherein the controller is configured to:
set a third reference trajectory located in a direction opposite to a place where the second reference trajectory is located with respect to the first reference trajectory; and
control the drive part such that the robot cleaner travels along the first reference trajectory and the second reference trajectory in a first reciprocate travel mode, and subsequently travels along the first reference trajectory and the third reference trajectory in a second reciprocate travel mode.

17. The robot cleaner of claim 16, wherein the controller is configured to control the drive part such that, after travelling in the first reciprocate travel mode, the robot cleaner travels along the first reference trajectory and subsequently travels in the second reciprocate travel mode.

18. The robot cleaner of claim 16, wherein the controller is configured to control the drive part such that a position of the robot cleaner on the first reference trajectory after travelling in the first reciprocate travel mode is identical to a position of the robot cleaner on the second reference trajectory after travelling in the second reciprocate travel mode.

19. The robot cleaner of claim 18, wherein the controller is configured to control the drive part such that, after travelling in the first reciprocate travel mode and the second reciprocate travel mode, the robot cleaner travels along the first reference trajectory and subsequently travels in the first reciprocate travel mode and the second reciprocate travel mode.

20. A method for controlling a travel of a robot cleaner, the method comprising:
determining reference trajectories on a coordinate system of a cleaning area;
determining at least one of a position and a direction of the robot cleaner based on at least one of information about a travel state of the robot cleaner and information about surroundings of the robot cleaner; and
compensating for a degree to which the robot cleaner is spaced apart from the reference trajectories based on the at least one of the position and the direction.
